(19) United States
(12) Patent Application Publication
(10) Pub. No.: US 2016/0024331 A1
(43) Pub. Date: Jan. 28, 2016

(54) Polymerizable Thiol-ene Ink and Coating Composition

(71) Applicant: Daniel William Catena, GREENVILLE, SC (US)

(72) Inventor: Daniel William Catena, GREENVILLE, SC (US)

(73) Assignee: KELMARDAN INTERNATIONAL INC., GREENVILLE, SC (US)

(21) Appl. No.: 14/807,641

(22) Filed: Jul. 23, 2015

Related U.S. Application Data
(60) Provisional application No. 62/027,902, filed on Jul. 23, 2014.

(51) Int. Cl. C09D 133/14; B05D 1/04; B05D 3/06; C09D 11/00; C09D 133/08

(52) U.S. Cl. CPC C09D 133/14; C09D 11/00; C09D 133/08; B05D 3/067; B05D 1/045

(57) ABSTRACT

Hybrid radiation curable and/or low temp thermal cured thiol-ene compositions containing a quantity of unsaturated oligomers, a quantity of unsaturated polymers, a quantity of unsaturated monomers, a quantity of mercapto compounds, a quantity of functional silanes compounds and an activation catalyst as well as a possible quantity of adjuvants, such as stabilizers, pigments, amine acrylates, fillers, film forming and rheology additives, cationic initiators and polymerization inhibitors. The quantity of mercapto compounds, the quantity of functional silane compounds, the quantity of unsaturated polymers, the quantity of unsaturated oligomers, the quantity of unsaturated monomers, and the activation catalyst are mixed in order to form a coating mixture. The coating mixture is used for coatings and inking onto imprintable surfaces.

The current application claims a priority to the U.S. Provisional Patent application Ser. No. 62/027,902 filed on Jul. 23, 2014.

### FIELD OF THE INVENTION

The present invention generally relates to polymerized compositions which are useful for difficult to coat substrates, such as ceramics, glass, polyolefins, polyamides, polyimides, polyfluoro plastics, stainless steel and the like. More specifically, the present invention relates to the use of such composition in the decoration and coating of glass containers, glass windows, glass screens and the like and plastic containers and substrates, automotive, medical, maintenance and general industrial coatings and inks. The composition provides non air inhibited rapid cure, abrasion and scratch resistance and durability.

### BACKGROUND OF THE INVENTION

Compositions containing thiol-ene chemistry are known in the art. For example, U.S. Pat. Nos. 8,378,052 and 8,557,346 and patent applications Ser. Nos. 11/586,501 and 12/879,117 and 2013/0171454 disclose the radiation activation of a metal catalyst, which is passivated by a mercapto compound to cure and convert hydroxyl isocyanate entities into a urethane. The patents/applied patents do not disclose or suggest the use of a functional silane compound or a stable compound not requiring the passivation of the catalyst.

U.S. Pat. No. 6,844,373 discloses a radiation cured composition containing one fluorine substituent, a reactive dye and a methacrylate urethane oligomer. This patent does not disclose or suggest the use of a functional silane compound.

U.S. Pat. No. 5,876,805 discloses the use of vinyl monomer or oligomer and a (meth) acrylic monomer or oligomer and a thiol compound radiation cured by photointiators more prevalent in the visible light range. This patent does not disclose or suggest the use of a functional silane compound.

WO 1996/012749 discloses a silane oligomer and urethane, area and thiourethanes cured by radiation for optical fiber coating. This patent does not disclose or suggest the use of a halogenated acoylated acrylic compound nor a hybrid cure mechanisms.

U.S. Pat. No. 4,849,649 discloses a radiation curable coating for optical glass fibers containing a monofunctional mercapto silane compound and a polyurethane acrylate. This patent does not disclose or suggest the use of a halogenated acrylated acrylic or a separate thio compound to regulate hybrid cure mechanisms.

WO 2004/101649 discloses a radiation curable coating for fiber optics and medical applications containing a multifunctional thio group, acyclicene and a carbonyl. This patent does not disclose the use of a functional silane compound.

WO 2006/055409 discloses the use of mercapto silanes with acrylated oiligomers to provide ultra-thin film non-air inhibited radiation curable coatings. This patent does not discuss or suggest the use of a thiol substituent separate from a mercapto silane, nor in a disclosure air inhibition is achieved through U.S. Pat. No. 6,541,537.

### SUMMARY OF INVENTION

The present invention relates to a stable composition capable of radiation activated catalysis and/or low thermal activated catalysis which comprises a mercapto group, unsaturated oligomer(s), unsaturated polymer(s), unsaturated monomer(s), functional silane(s) photoinitiators and/or thermal catalysts and optional adjuvants, such as stabilizers, pigments, amine acrylates fillers, cationic intiators, film forming and rheology additives and polymerization inhibitors. A characteristic of the composition is its reduced surface tension, another characteristic is its rapid cure as compared to other radiation curable compounds. The combination of these two characteristics provides excellent adhesion and low shrinkage during cure. The composition may be formulated to serve as a protective, functional or decorative ink or coating for hard to adhere to substrates including for example, alloys of stainless steel, plastic, glass, and ceramic, as well as most other wood, metal or composite substrates. For extreme abrasion, temperature cycling and harsh environments, the use of a water based hybrid thermal radiation cure acrylated acrylic, methacryl functional silane and silane terpolymer pretreatment/primer/tiecoat such as those compositions embodied in U.S. Pat. No. 6,541,537 can further enhance the film properties.

Still other objects and advantages of the present invention will become reading apparent by those skilled in the art from the detailed description, where in it is shown and described only in the preferred embodiments, simply by illustration of the best mode. As will be realized, the present invention is capable of other and different embodiments, and its several details are capable of modifications in various respects, without departing from the present invention. Accordingly, the description is to be regarded as illustrative, in nature, and not as restrictive.

### BRIEF DESCRIPTION OF THE DRAWINGS

FIG. 1 is a flow diagram detailing the overall method of the present invention.

FIG. 2 is a flow diagram detailing an embodiment of the present invention incorporating actinic radiation.

FIG. 3 is a flow diagram detailing an embodiment of the present invention incorporating a thermal catalyst and a quantity of adjuvants.

### DETAILED DESCRIPTIONS OF THE INVENTION

All illustrations of the drawings are for the purpose of describing selected versions of the present invention and are not intended to limit the scope of the present invention.

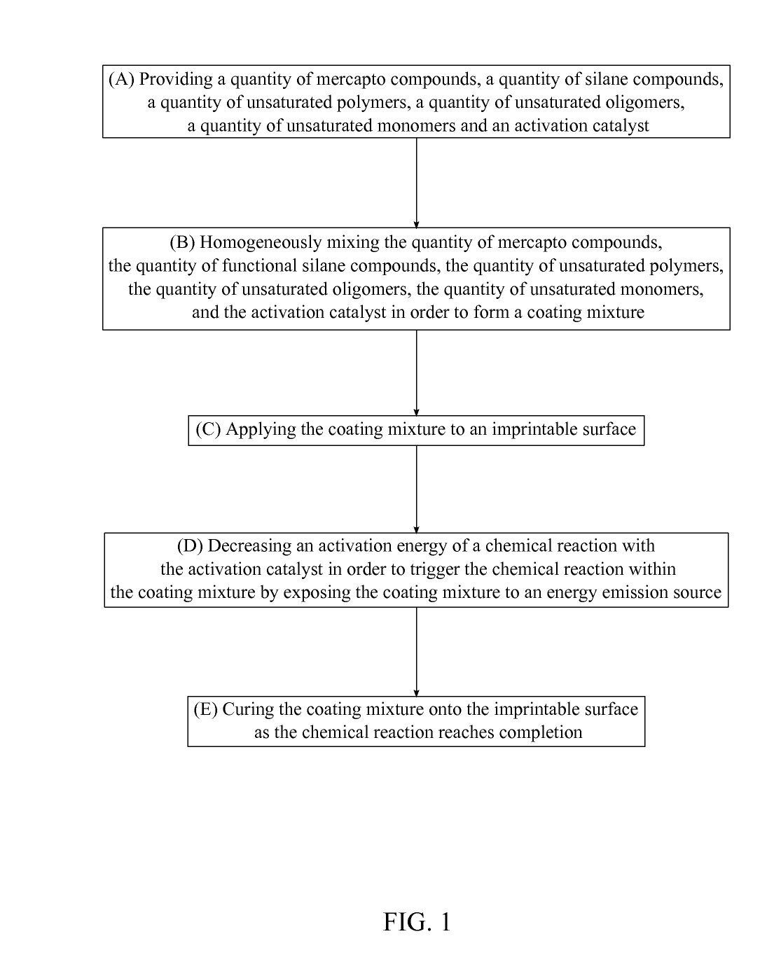

The present invention is a method of forming a polymerizable thiolene ink and coating composition which provides excellent adhesion and low shrinkage when cured onto an imprintable surface. An imprintable surface is any surface which can be printed or coated to the aesthetic preference of the user. In order to carry out the present invention, a number of chemical compounds are provided including: a quantity of mercapto compounds, a quantity of functional silane compounds, a quantity of unsaturated polymers, a quantity of unsaturated oligomer compounds, a quantity of unsaturated monomers, and an activation catalyst which impart desired properties to the present invention. In accordance to FIG. 1, the quantity of mercapto compounds, the quantity of functional silane compounds, the quantity of unsaturated polymers, the quantity of oligomer compounds, the quantity of unsaturated monomers are homogenously mixed to form a coating mixture. Once the coating mixture is formed, the coating mixture is then applied onto an imprintable surface. The activation catalyst decreases the activation energy of a chemical reaction within the coating mixture resulting from exposing the coating mixture to an energy emission source. The energy emission source outputs heat and/or light to provide the activation energy needed to initiate the chemical reaction. The coating mixture is stable until exposed to the energy emission source such that it is able to be transported and stored. The coating mixture is cured onto an imprintable surface as the chemical reaction reaches completion after exposure to the energy emission source. The chemical reaction is thiol-ene “Click Chemistry” which provides extremely rapid gel curing on the order of two to five times faster than the induction triggered gel curing of previous radiation or thermal ink and coating mixtures. The chemical reaction imparts little to no shrinkage of the inks or coatings on the imprintable surface, thus providing desirable adhesion and durability properties. Other similar mixtures without the thiol-ene chemistry lose adhesion properties, due to the longer initiation of the curing stage, as the ink or coating shrink into itself and pull away from the imprinted substrate resulting in loss of adhesion, constituting poor durability properties.

The quantity of mercapto compounds is any mercapto compounds that can react with an olefinic compound. The quantity of mercapto compounds provides increased reactivity of the radiation and/or thermal cure properties through the almost instantaneous mercapto “Click Chemistry”. The quanity of mercapto compounds also enhances rheology, durability and adhesion properties. In accordance to the preferred embodiment of the present invention, the quantity of mercapto compounds is appoximately 1-25% by weight (wt.) of the coating mixture. Typically, the quantity of mercapto compounds is selected from a group consisting of: trimethylolpropane tri(3-mercapto-thiopropionate); pentaerythrital tetra-(3-mercapto-thiopropionate); glycol di-(3-mercapto-thiopropionate); dipentaerythritol hexa-(3-mercapto-thiopropionate); trimethylolpropane trithioglycate; mercapto diallyl ether; mercaptopropionic acid and esters thereof; thiophenol; methylthioglycolate; mercaptosilanes; pentaerythritol tetra (3-mercaptobutylate); and combinations thereof. In some embodiments of the present invention the quantity of mercapto compounds additionally includes, but is not limited to: glycol mercapto acetate; ethane dithiol; thiolactic acid; thio acetic acid; 2-mercaptoethanol; 1,4-butanedithiol; 2,3 mercapto propanol; toluene-3,4-dithiol, alpha, alphadimercapto-para-xylene; thiosalisylic acid; mercapto acetic acid; dodecane dithiol; didodecane dithiol; di-thio-phenol; di-para-chlorothiophenal; dimercapto benzothiazole; 3,4 dimercapto toluene; 1-octane thiol, parathiocresol; 2,3,5,6-tetrafluorothiophenol; cyclohexylmercaptan; various mercapto pyridines; dithiocrythritol; 6-ethoxy-2-mercaptobenzothiazole; dilmonene dimercaptan y-mercapto silane; and combinations thereof.

The quantity of unsaturated monomers is an unsaturated monomer compound that can react with a mercapto compound in a thiolene type reaction. The quantity of unsaturated monomers provides viscosity adjustment and improved wetting and rheology characteristics, as well as preventing polymer entanglement and shorter polymer chains during the cure process. Typically, the quantity of unsaturated monomers is approximately 0-70% wt. of the coating mixture. The quantity of unsaturated monomers is selected from a group consisting of: ethoxylated nonylphenol acraylated; isobornyl acrylate; phenoxyethyl acrylate; o-phenyl phenoxyethyl acrylate; 2-(2-ethoxyethoxy)ethyl acrylate; octyl decyl acrylate; isodecyl acrylate; laurel acrylate; hexanediol diacrylate; ethoxylated bisphenol A diacrylate; neopentylglycol diacrylate; dipropylene glycol diacrylate; ethoxylated hexanediol diacrylate; trimethylolpropane triacrylate; pentaerythrital triacrylate; pentaerythrital tetraacrylate; laurel methacrylate; stearyl methacrylate; tridecyl methacrylate; vinyl pyrrilodone; vinyl capralactam; allyl methacrylate; ethylene glycol dimethacrylate; 1,4 butanediol dimethacrylate; 1,6 hexanediol dimethacrylate; neopentyl glycol dimethacrylate; ethoxylated bisphenol A dimethacrylate; trimethylolpropane trimethacrylate; dipentaerythritol pentaacrylate; trimethylolpropane monoallyether; trimethylolpropane diallylether; and combinations thereof. In some embodiments for the quantity of unsaturated monomers, the quantity of unsaturated monomers additionally includes, but are not limited to: ethoxylated phenol acrylate; ethoxylated nonylphenol monoacrylate; cyclic trimethyl propane formal acrylate; tetrahydrafurfuryl acrylate; 2-((butylamino)carbonyl)oxy)ethyl acrylate; propoxylated neopentylglycol; monomethyl ether acrylate polyethylene glycol 200, 400, and 600, diacrylate; tripropylene glycol diacrylate; propoxylated hexanediol diacrylate; propoxylated trimethylolpropane triacrylate; propxylated glyceryl triacrylate; tris(2-hydroxy ethyl)isocyanurate triacrylate; pentaerythrital triacrylate; pentaerythrital tetraacrylate; ethoxylated pentaerythritol tetracrylate; ditrimethyl propane tetra-acrylate; dipentaerythritol; hexa acrylate; tetrahydrofurfuryl methacrylate; cyclohexyl methacrylate; n-hexyl methacrylate; 2-ethoxyethyl methacrylate; isodecyl methacrylate; 2-methoxy acrylate; stearyl acrylate; caprolactone acrylate; polypropylene glycol monomethacrylate; polypropylene glycol monoacrylate; trietheylene glycol dimethacrylate tetraethylene glycol dimethacrylate; polyethylene glycol dimethacrylate; 1,4 butandiol diacrylate; polyethylene glycol dimethacrylate; 1,3 butylene glycol dimethacrylate; tris(2-hydroxy ethyl)isocyanurate trimethylacrylate; and combinations thereof.

The quantity of unsaturated polymers and the quantity of unsaturated oligomers can react with a mercapto compound in a thiol-ene type reaction. The quantity of unsaturated polymers and the quantity of unsaturated oligomers are the backbone of the product, providing the durability, toughness, crosslink density and weatherability characteristics of the coating mixture in the present invention. Typically, the quantity of unsaturated polymers is approximately 10-80% wt. of the coating mixture. Similarly, the quantity of unsaturated oligomers is approximately 10-80% wt. of the coating mixture. The quantity of unsaturated polymers is acrylated acrylic terpolymers. The acrylated acrylic terpolymers comprise reactive epoxide groups capable of undergoing cationic reactions and conjugated double bonds which undergo actinic reactions, such compounds are detailed in U.S. Pat. No. 6,541,537 (Catena). The quantity of oligomers is selected from a group consisting of: aliphatic epoxy acrylate; aromatic epoxy acrylate; aliphatic urethane; aromatic urethanes; polyester acrylates; epoxidized soybean oil; epoxidized linseed oil; butadiene; poly butadiene; isocyanutates; cationic epoxies; amine acrylates; polyether acrylates; polyamides; modified polyester acrylates; modified polyether acrylates; halogenated polyesters; poly triazole; polymidines; allophonates; biurets; and combinations thereof.

In accordance to the preferred embodiment, the quantity of functional silane compounds reacts with a mercapto compound in a thiol-ene type reaction. The quantity of functional silane compounds provides adhesion and wetting properties to low dyne/cm surface tension substrates. The quantity of functional silane compounds also provides elastomeric properties without sacrificing durability, and also provides reduction in viscosity for better flow and leveling properties and being a reactive component there is no migration issues. Typically, the quantity of functional silane compounds is 1-25% wt. of the coating mixture. The quantity of functional silane compounds is selected from a group consisting of: acryl silanes; acryl polysiloxanes; methacryl silanes; methacryl polysiloxane; acrylimido silanes; methacrylimido silanes; acryl polysilanes; methacryl polysilanes; acrylimido polysilanes; methacrylimido polysilanes; vinyl silanes; vinyl polysiloxanes; vinylpolysilanes; and combinations thereof.

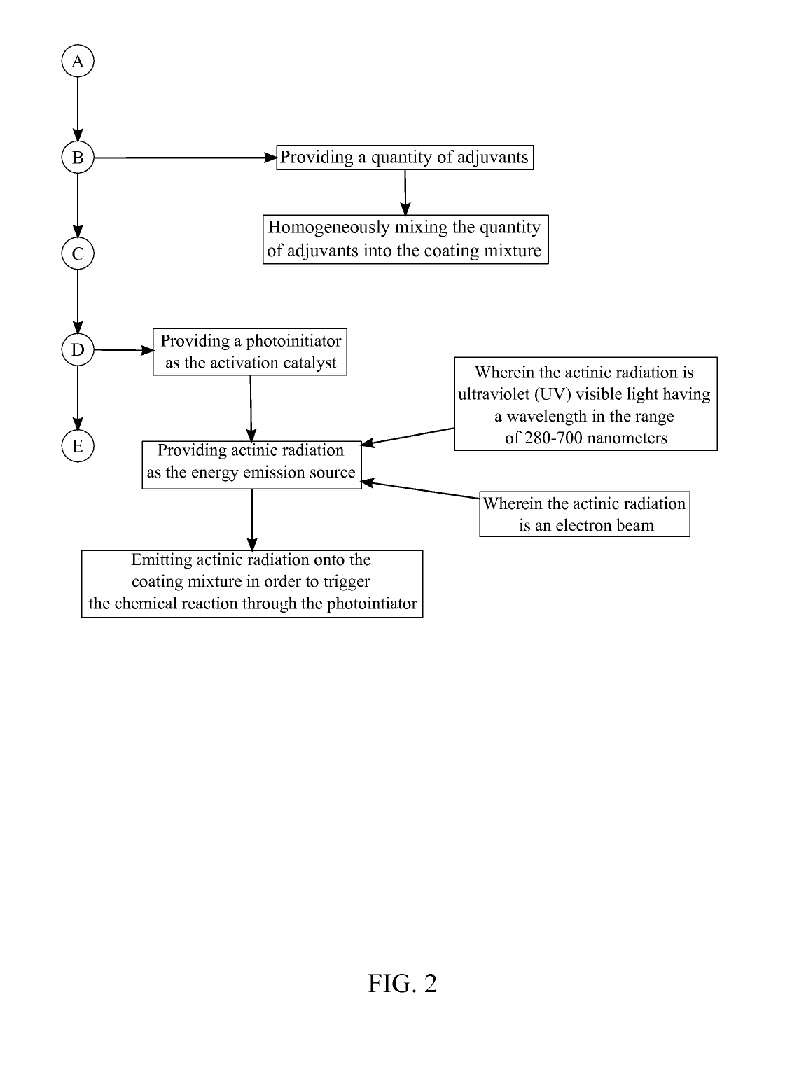

In some embodiments of the present invention as detailed in FIG. 2, the present invention provides actinic radiation as the energy emission source and a photoinitiator as the activation catalyst. The photointiator facilitates the triggering of the chemical reaction by lowering the activation energy of the chemical reaction when actinic radiation is emitted onto the coating mixture. In some embodiments of the present invention, the actinic radiation is ultraviolet (UV) visible light having a wavelength in the range of 280-700 nanometers to effectively trigger the chemical reaction. Alternatively, the actinic radiation is an electron beam which is capable of providing the necessary input energy to initiate the chemical reaction. In accordance to the preferred embodiment, the photoinitiator is approximately 0-15% wt. of the coating mixture. The photointiator compound is selected from a group consisting of: benzophenane; 1-hydroxycycohexyl phenylacetane; 2-benzyl-2-(dimethylamino)-4-morpholinobutyrophenone; 2,2-dimethoxy-2-phenylacetophenone; bis(cyclopentadienyllbis(2,6-difluero-3-(1-pyrrl)phenyl)Titanium; phenylbis(2,46-trimethylbenzayl)phosphine oxide; 2-methyl-4′-(methylthio)-2-morpholino-propiophenone; 2-hydroxy-2-methylpropriophenone; bis(2,C-dimethoxy benzoyl)(2,4,4-trimethyl pentyl)phoshine oxide; 2-hydroxy-4′-(2-hydroxy ethoxy)-2-methylthiaprapian phenene; diphenyl(2,4,6-trimethybenzeyl)phosphine oxide; and combinations thereof, as well as, including polymeric derivatives of the aforementioned compounds.

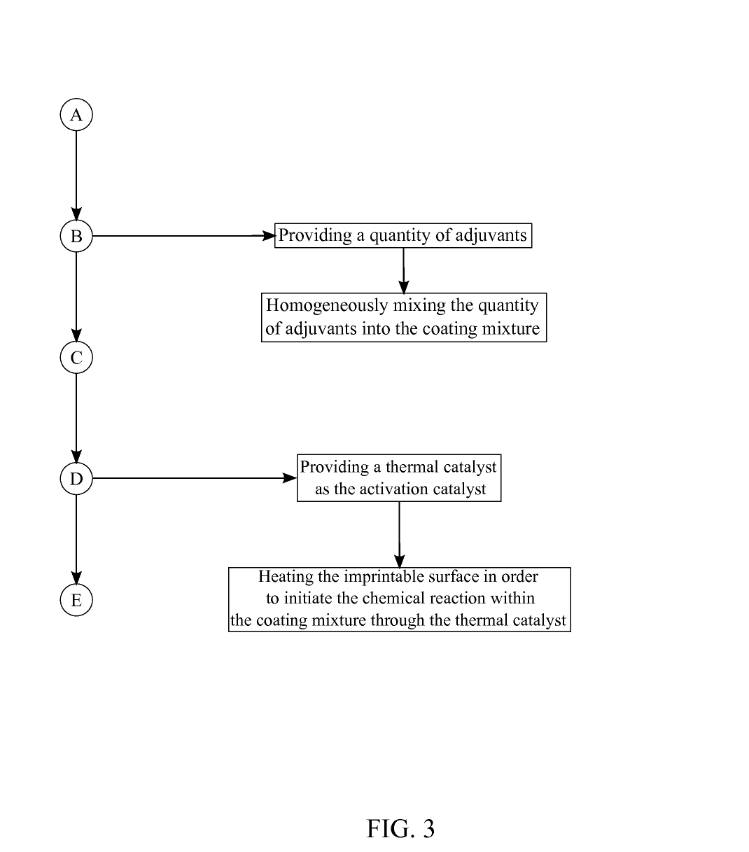

In some embodiments of the present invention, the present invention provides a thermal catalyst as the activation catalyst, as shown in FIG. 3. The imprintable surface is heated in order to trigger the chemical reaction through the thermal catalyst. In accordance to the preferred embodiment, the energy emission source is an oven, specifically a short-wave or medium-wave infrared oven. The oven provides a high temperature to initiate the chemical reaction. The thermal catalyst compound is approximately 0.005-10% wt. of the coating mixture. The thermal catalyst is selected from a group consisting of: peroxide; peroxyester; percarbonate compounds; azonitrile compounds; and combinations thereof. The thermal catalyst compound has a half-life of less than 10 minutes at 150° Celsius.

An important note is that the present invention can provide both the photoinitiator and the thermal catalyst as the activation catalysts and therefore incorporates both the actinic radiation and the oven as the energy emission source.

In one application of the present invention on the current durable glass deco business, there is an extremely high energy cost and color limitations due to heavy metal content, such as cadmium for reds and yellows and require long high temperature, greater than 600° Celsius, in a lehr oven for 1-2 hours. The present invention allows curing by UV visible light in the range of 280-700 nanometer wavelength in less than 30 seconds, a combination of actinic radiation and thermal cure of less than 2 seconds, or a thermal cure of 2-10 minutes at a peak surface temperature of less than 150° C. The inks or coatings can be applied by most spray, print, inkjet or laser processes.

For use on plastic containers, curing the present invention by the actinic radiation allows the user to decrease light energy cure intensity and dwell time by greater than 40% or to increase the line speed if applicable, thus having less distortion and degradation of the plastic container. The inks or coatings can be applied by most spray, print, inkjet or laser processes.

In another application of the present invention, the on-site application of the present invention including actinic radiation for concrete, wood, tiles, and like materials reduces the time and temperature effects while increasing durability and chemical resistance. The coating mixture is cured as quickly as it is exposed to the actinic radiation, rather than 2-48 hours for typical commercial products in current use. Floor maintenance coatings made from the present invention cure faster than 200 linear feet per min. to a hard abrasion and chemical resistant coating. The coatings mixture is applied by the conventional means of coating an imprintable surface.

In another application of the present invention, a quantity of silver nanoparticles may be dispersed in the composition to provide coatings for medical instruments and utilities to help prevent staph transfer infections and kill bacteria, the latter also makes it an ideal coating for inside refrigerated appliances. The present invention may be applied by most spray or deposition processes.

In some embodiments of the present invention, the present invention provides a quantity of adjuvants. In accordance to FIG. 2 and FIG. 3, the quantity of adjuvants allows for the adjustment of color and rheological properties of the coating mixture such that the coating mixture is easier to apply onto an imprintable surface and aesthetically pleasing. The quantity of adjuvants is homogeneously mixed into the coating mixture such that the color and rheological properties are consistent throughout the present invention. The quantity of adjuvants includes, but is not limited to: pigments; fillers; amine acrylates; cationic initiators; film forming additives; rheological additives and polymerization inhibitors.

### EXAMPLE 1

The following composition was tested for automotive carbon fiber reinforced polyamide minor housings and bumper fascia:

| | | Percent weight |
|---|---|---|
| | | of the specific |
| | | embodiment |
| | | of the coating |
| Compound | Role | mixture |
| RENCRYL 1955 | Acrylated Acrylic Polymer | 29.3% |
| RENCRYL 4070 | Acrylated Isocyanate | 8.4% |
| | Adduct Oligomer | |
| 1,6-hexanediol diacrylate | Unsaturated Monomer | 10.3% |
| Ethoxylated 1,6-hexanediol | Unsaturated Monomer | 12.1% |
| diacrylate | | |
| Vinyl-caprolactam | Unsaturated Monomer | 3.4% |
| Ciba Irgacure 1173 | Actinic Photoinitiator | 0.8% |
| Ciba Irgacure 184 | Actinic Photoinitiator | 2% |
| Dow Cyacure UVI-6974 | Cationic Photoinitiator | 0.5% |
| Ciba Benzophenone | Actinic Photoinitiator | 2.0% |
| Efka 3035 | Rheological Adjuvant | 1% |
| Efka 2721 | Rheological Adjuvant | 0.7% |
| GE A-174NT | Methacryl Functional | 4% |
| | Silane | |
| Pentaerythritol tetra-(3- | Mercapto Compound | 5% |
| mercapto thiopropionate) | | |
| Titanium Dioxide | Pigment Adjuvant | 20% |
| Carbon Black | Pigment Adjuvant | 1% |

The present invention is applied to the imprintable surface, an automotive carbon fiber reinforced polyamide mirror housings and bumper fascia, through use of an electrostatic spraying device. The coating mixture was then cured using d-bulb type UV emitter. Without the use of a primer, the coating mixture is exposed to UV visible light at a flux of 300 microjoules per square centimeter (mj/sq.cm). When using a water based terpolymer, which has been previously applied to the imprintable surface, the coating mixture is exposed to the UV visible light at a flux of 300 mj/sq.cm and exposed to a temperature of 250 degrees Fahrenheit for 10 minutes.

### Example 1 Test Results

When applying a crosshatch and tape test onto the coating mixture after curing, the present invention had approximately half of the coating mixture removed from the imprintable surface when no primer was used in the process and none of the coating mixture removed when a primer has been applied.

When applying a methyl ethyl ketone (MEK) double rubbing test onto the cured coating mixture, the present invention softens after about 200 rubs when there was no primer used in conjunction with the coating mixture, but remains intact and structurally unaffected when the primer is used.

When applying a salt spray test for 500 hours onto the coating mixture once cured, the coating mixture did not remain on the imprintable surface when there was no use of primer in conjunction with the coating mixture. However, when the primer is used in conjunction with the coating mixture, there was not any loss of the present invention on the imprintable surface when exposed to the same salt spray test.

When applying a quick ultraviolet (QUV) to simulate various weather conditions test for 1000 hours onto the cured coating mixture, the coating mixture does not remain adhered to the imprintable surface without the incorporation of the primer; however, with the incorporation of the primer, the cured coating mixture does not degrade over the duration of the test.

When applying a hardness test similar to determining the hardness of a pencil, the cured coating mixture has been determined to have a pencil hardness of 5 H without the incorporation of a primer, and a pencil hardness of 8 H when the primer is incorporated.

### EXAMPLE 2

The following composition was tested for onsite floor maintenance coatings on new oak wood fine sanded finish and a lightly scuffed concrete floor:

| | | Percent weight |
|---|---|---|
| | | of the specific |
| | | embodiment |
| | | of the coating |
| Compound | Role | mixture |
| RENCRYL 1955 | Acrylated Acrylic Polymer | 23.1% |
| RENCRYL 4070 | Acrylated Isocyanate Adduct | 11.5% |
| | Oligomer | |
| 1,6-hexanediol diacrylate | Unsaturated Monomer | 42.9% |
| Ciba Irgacure 1173 | Actinic Photoinitiator | 1% |
| Ciba Irgacure 184 | Actinic Photoinitiator | 2.5% |
| Dow Cyacure UVI-6974 | Cationic Photoinitiator | 0.5% |
| Ciba Benzophenone | Actinic Photoinitiator | 2.5% |
| GE A-174NT | Methacryl Functional Silane | 4% |
| Pentaerythritol tetra-(3- | Mercapto Compound | 5% |
| mercapto thiopropionate) | | |
| Tego Foamex N | Air Release Adjuvant | 2% |
| Albermarle M-4 | Polyamide Flattening | 5% |
| | Adjuvant | |

### Example 2 Test Results

The present invention is applied to concrete and wood floors, constituting the imprintable surface, then cured with a d-bulb type UV visual light emission source covering an area of 300 linear feet per minute with an emission flux of 292 mj/sq.cm. The present invention passes a 200 rubbing MEK double rub test with no mass loss of the cured coating mixture. Both coated surfaces did not have any mass loss of the cured coating mixture when a quart of acetone was poured onto the imprintable surface and let sit for ten minutes. Once the ten minutes elapsed the acetone was wiped dry to reveal no effect on the cured coating mixture over this duration for either of the coated surfaces. Both passed being driven over with a fork lift immediately after curing with no effect.

Although the invention has been explained in relation to its preferred embodiment, it is to be understood that many other possible modifications and variations can be made without departing from the spirit and scope of the invention as hereinafter claimed.

What is claimed:

1. A method of forming and using a polymerizable thiolene ink and coating composition, the method comprises the steps of:
providing a quantity of mercapto compounds, a quantity of silane compounds, a quantity of unsaturated polymers, a quantity of unsaturated oligomers, a quantity of unsaturated monomers and an activation catalyst;
homogeneously mixing the quantity of mercapto compounds, the quantity of functional silane compounds, the quantity of unsaturated polymers, the quantity of unsaturated oligomers, the quantity of unsaturated monomers, and the activation catalyst in order to form a coating mixture;
applying the coating mixture to an imprintable surface;
decreasing an activation energy of a chemical reaction with the activation catalyst in order to trigger the chemical reaction within the coating mixture by exposing the coating mixture to an energy emission source; and
curing the coating mixture onto the imprintable surface as the chemical reaction reaches completion.

2. The method of forming a polymerizable thiolene ink and coating composition, the method as claimed in claim 1, wherein the quantity of mercapto compounds is approximately 1-25% by weight of the coating mixture.

3. The method of forming a polymerizable thiolene ink and coating composition, the method as claimed in claim 1, wherein the quantity of functional silane compounds is approximately 1-25% by weight of the coating mixture.

4. The method of forming a polymerizable thiolene ink and coating composition, the method as claimed in claim 1, wherein the quantity of unsaturated polymers is approximately 10-80% by weight of the coating mixture.

5. The method of forming a polymerizable thiolene ink and coating composition, the method as claimed in claim 1, wherein the quantity of unsaturated oligomers is approximately 10-80% by weight of the coating mixture;

6. The method of forming a polymerizable thiolene ink and coating composition, the method as claimed in claim 1, wherein the quantity of unsaturated monomers is approximately 0-70% by weight of the coating mixture.

7. The method of forming a polymerizable thiolene ink and coating composition, the method as claimed in claim 1, wherein the quantity of mercapto compounds is selected from the group consisting of: trimethylolpropane tri(3-mercapto-thiopropionate); pentaerythrital tetra-(3-mercapto-thiopropionate); glycol di-(3-mercapto-thiopropionate); dipentaerythritol hexa-(3-mercapto-thiopropionate); trimethylolpropane trithioglycate; mercapto diallyl ether; mercaptopropionic acid and esters thereof; thiophenol; methylthioglycolate; mercaptosilanes; pentaerythritol tetra(3-mercaptobutylate); and combinations thereof.

8. The method of forming a polymerizable thiolene ink and coating composition, the method as claimed in claim 1, wherein the quantity of functional silane compounds is selected from the group consisting of: acryl silanes; acryl polysiloxanes; methacryl silanes; methacryl polysiloxane; acrylimido silanes; methacrylimido silanes; acryl polysilanes; methacryl polysilanes; acrylimido polysilanes; methacrylimido polysilanes; vinyl silanes; vinyl polysiloxanes; vinylpolysilanes; and combinations thereof.

9. The method of forming a polymerizable thiolene ink and coating composition, the method as claimed in claim 1, wherein:
the quantity of unsaturated polymers is acylated acrylic terpolymer;
the acylated acrylic terpolymer comprises reactive epoxide groups and conjugated double bonds;
the reactive epoxide groups are capable of undergoing cationic reactions; and
the conjugated double bonds are capable of undergoing actinic reactions.

10. The method of forming a polymerizable thiolene ink and coating composition, the method as claimed in claim 1, wherein the quantity of unsaturated oligomers is selected from the group consisting of: aliphatic epoxy acrylate; aromatic epoxy acrylate; aliphatic urethane; aromatic urethanes; polyester acrylates; epoxidized soybean oil; epoxidized linseed oil; butadiene; poly butadiene; isocyanutates; cationic epoxies; amine acrylates; polyether acrylates; polyamides; modified polyester acrylates; modified polyether acrylates; halogenated polyesters; poly triazole; polymidines; allophonates; biurets; and combinations thereof.

11. The method of forming a polymerizable thiolene ink and coating composition, the method as claimed in claim 1, wherein the quantity of unsaturated monomers is selected from the group consisting of: ethoxylated nonylphenol acraylated; isobornyl acrylate; phenoxyethyl acrylate; o-phenyl phenoxyethyl acrylate; 2-(2-ethoxyethoxy)ethyl acrylate; octyl decyl acrylate; isodecyl acrylate; laurel acrylate; hexanediol diacrylate; ethoxylated bisphenol A diacrylate; neopentylglycol diacrylate; dipropylene glycol diacrylate; ethoxylated hexanediol diacrylate; trimethylolpropane triacrylate; pentaerythrital triacrylate; pentaerythrital tetraacrylate; laurel methacrylate; stearyl methacrylate; tridecyl methacrylate; vinyl pyrrilodone; vinyl capralactam; allyl methacrylate; ethylene glycol dimethacrylate; 1,4 butanediol dimethacrylate; 1,6 hexanediol dimethacrylate; neopentyl glycol dimethacrylate; ethoxylated bisphenol A dimethacrylate; trimethylolpropane trimethacrylate; dipentaerythritol pentaacrylate; trimethylolpropane monoallyether; trimethylolpropane diallylether; and combinations thereof.

12. The method of forming a polymerizable thiolene ink and coating composition as claimed in claim 1 comprises:
providing a photoinitiator as the activation catalyst;
providing actinic radiation as the energy emission source; and
emitting actinic radiation onto the coating mixture in order to trigger the chemical reaction through the photointiator.

13. The method of forming a polymerizable thiolene ink and coating composition as claimed in claim 12, wherein the actinic radiation is ultraviolet (UV) visible light having a wavelength in the range of 280-700 nanometers.

14. The method of forming a polymerizable thiolene ink and coating composition as claimed in claim 12, wherein the actinic radiation is an electron beam.

15. The method of forming a polymerizable thiolene ink and coating composition, the method as claimed in claim 12, wherein the photoinitiator is approximately 0-12% by weight of the coating mixture.

16. The method of forming a polymerizable thiolene ink and coating composition, the method as claimed in claim 1, wherein the photoinitiator is selected from a group consisting of: benzophenane; 1-hydroxycycohexyl phenylacetane; 2-benzyl-2-(dimethylamino)-4-morpholinobutyrophenone; 2,2-dimethoxy-2-phenylacetophenone; bis(cyclopentadienyllbis(2,6-difluero-3-(1-pyrrl)phenyl)Titanium; phenylbis(2,46-trimethylbenzayl)phosphine oxide; 2-methyl-4′-(methylthio)-2-morpholino-propiophenone; 2-hydroxy-2-methylpropriophenone; bis(2,C-dimethoxy benzoyl)(2,4,4-trimethyl pentyl)phoshine oxide; 2-hydroxy-4′-(2-hydroxy ethoxy)-2-methylthiaprapian phenene; diphenyl(2,4,6-trimethybenzeyl)phosphine oxide; and combinations thereof.

17. The method of forming a polymerizable thiolene ink and coating composition as claimed in claim 1 comprises:
providing a thermal catalyst as the activation catalyst; and
heating the imprintable surface in order to initiate the chemical reaction within the coating mixture through the thermal catalyst.

18. The method of forming a polymerizable thiolene ink and coating composition, the method as claimed in claim 1, wherein the thermal catalyst being approximately 0.005-10% by weight of the coating mixture.

19. The method of forming a polymerizable thiolene ink and coating composition, the method as claimed in claim 1, wherein the thermal catalyst being selected from a group consisting of: peroxide; peroxyester; percarbonate compounds; azonitrile compounds; and combinations thereof.

20. The method of forming a polymerizable thiolene ink and coating composition as claimed in claim 1 comprises:
providing a quantity of adjuvants; and
homogeneously mixing the quantity of adjuvants into the coating mixture.
